(19) United States
(12) Patent Application Publication
(10) Pub. No.: US 2008/0111276 A1
(43) Pub. Date: May 15, 2008

(54) GRIP CAP

(76) Inventors: John J. Hahn, Hartford, WI (US); Brian R. Hartlmeier, Elm Grove, WI (US)

Correspondence Address: BOYLE FREDRICKSON S.C., 840 North Plankinton Avenue, MILWAUKEE, WI, 53203, US

(21) Appl. No.: 12/016,650

(22) Filed: Jan. 18, 2008

Related U.S. Application Data
(62) Division of application No. 10/621,830, filed on Jul. 17, 2003.

(51) Int. Cl. B29C 45/16

(52) U.S. Cl. 264/268

(57) ABSTRACT

A grip cap for a container has a thermoplastic shell in an inverted cup shape with a top wall and a skirt bounded by a lower rim. An elastomeric layer is integrally molded to the cap shell along the outer surface of the top wall and the skirt as well as along the underside of the lower rim. This layer defines multiple spaced apart and raised vertical ribs joined by a pad at the top wall and a gasket extending along the lower rim. The ribs and the pad provide a cushion and the gasket can seal against a shoulder of the container when tightened. Also disclosed is a two-shot method of molding such a grip cap, including integral resilient material at the outer surfaces and the underside of the cap shell rim.

### CROSS REFERENCE TO RELATED APPLICATION

The present application is a divisional of U.S. patent application Ser. No. 10/621,830 filed on Jul. 17, 2003, entitled GRIP CAP, and is expressly incorporated by reference.

### STATEMENT REGARDING FEDERALLY SPONSORED RESEARCH OR DEVELOPMENT

--

### BACKGROUND OF THE INVENTION

1. Technical Field

The present invention relates to container closure caps and the like and, in particular, to lightweight plastic caps having improved gripping and sealing surfaces.

2. Description of the Related Art

It is well known to close openings in containers by snapping or threading caps onto the mouths of the containers. Vertical ridges are commonly formed in thread on caps to increase the grippable surface area of the caps and make it easier to screw the caps onto the containers. The grip is further improved by having soft, tactile material along the outer surfaces of the caps. U.S. Pat. Nos. 5,865,353 and 6,257,431 describe containers having caps with elastomeric gripping zones arranged on mating parts of hinged caps that facilitate opening the caps.

Sealing is another issue for closure caps, particularly for liquids and perishable ingestible goods. U.S. Pat. No. 4,143,785 discloses a cap with special inner flanges that seal against the inner and outer diameters of the container to which the cap is threaded. U.S. Pat. Nos. 4,308,965 and 4,461,393 describe improved sealing arrangements in which the caps are formed of two dissimilar plastic materials using a two-shot molding process in which a more rigid material forms the main bodies of the caps and softer, relatively resilient seals are formed on the inside of the caps. The two-shot molding process fuses the dissimilar materials together as a unitary component, without additional bonding techniques being required.

### SUMMARY OF THE INVENTION

The present invention is a grip cap having a generally inelastic shell and a resilient grip layer formed in a two-shot molding process to be a unitary part with improved gripping and sealing attributes.

In particular, the present invention provides a grip cap having a cap shell, defining a top wall and a skirt depending down from the top wall to a lower rim for receiving a neck of the container. A plurality of raised ribs, resilient relative to the cap shell, are integrally molded to an outer surface of the cap shell in spaced relation and extending along the skirt between the top wall and the lower rim.

In another aspect of the invention, the lower rim of the cap shell has an underside that faces generally away from the top wall. A relatively resilient grip layer is integrally molded to the cap shell so that a plurality of raised ribs extend along the outer surface of the skirt and so that a gasket extends along the underside of the lower rim.

In various preferred forms, the ribs are spaced equi-angularly about an axis about which the cap shell is concentric and are joined at an elastomeric top pad of a diameter less than the top wall of the cap shell and at a ring-shaped gasket extending under the lower rim to abut a shoulder of the container when the cap is in position closing the container. The shell is molded to extend upward through the top pad to present raised indicia. The ribs and the shell can be the same or contrasting colors. The cap shell can have one or more flanges extending down from the top wall that engage and retain an inner cap removably mounted over the mouth of the container.

In yet another aspect the invention provides a two-shot method of making a grip cap for a container. The method includes injecting a thermoplastic resin between first and second die parts to form a cap shell conforming to the interior of the die so as to have a top wall and a skirt bounded by a lower rim at an angle to an outer surface of the skirt, then, supporting the cap shell on the first die part and interchanging the second die part with a third die part. The cap shell is allowed to shrink on the first die part as it cools so that the lower rim is spaced from an adjacent surface of the first die part. The first and third die parts are then brought together with the cap shell therebetween and an elastomeric resin is injected between the cap shell and the first and third die parts to mold a grip layer integrally with the cap shell having a plurality of raised ribs extending along the outer surface of the skirt and a gasket extending along the lower rim.

Thus, grip cap of the present invention has an improved gripping surface for a user's fingers when loosening the cap from or tightening the cap onto a container. The ribs and top pad provide cushioning for the underlying shell against possible impact while using minimal amounts of the elastomeric material. The gasket may provide for resilient sealing against the container and frictional contact holding the cap closed against rotation when it is sealed. The grip cap can be adapted to be connected to conventional threaded and other suitable under closures for closing an opening in the container.

These and still other advantages of the invention will be apparent from the detailed description and drawings. What follows is a preferred embodiment of the present invention. To assess the full scope of the invention the claims should be looked to as the preferred embodiment is not intended as the only embodiment within the scope of the invention.

### BRIEF DESCRIPTION OF THE DRAWINGS

FIG. 1 is an exploded perspective view of the grip cap of the present invention with a corresponding container;

FIG. 2 is a partial cross section of the grip cap of FIG. 1 taken along line 2-2;

FIG. 3 is a partial sectional view of a two part die shown in position to mold a generally rigid shell of the grip cap;

FIG. 4 is a view similar to FIG. 3 showing the cap shell supported on one part of the die with the other part removed and showing that the cap shell has shrunk somewhat on the die so that a lower rim of the cap shell is spaced therefrom; and

FIG. 5 is another similar view showing the die with the cap shell on the associated disc part and a new mating die part in position to mold an elastomeric grip layer onto the cap shell.

### DETAILED DESCRIPTION OF THE PREFERRED EMBODIMENT

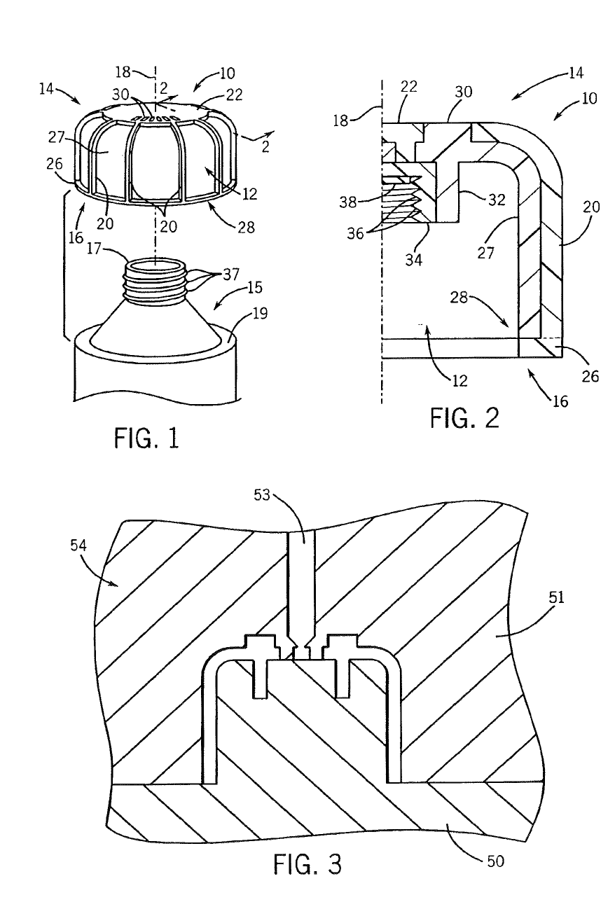

Referring to FIGS. 1 and 2, a grip cap 10, suitable as a screw lid or other type of closure for a container 15, may include a cup-shaped, cylindrical cap shell 12 generally symmetrical about a central vertical axis 18. The shell 12 has a top wall 14 from which a skirt 27 depends downward, which is bounded by a lower rim 28, all of which defines an open underside 16 that may receive a neck 17 of the container 15 as will be described.

The cap shell 12 may be preferentially molded of a relatively inelastic thermoplastic resin such as polypropylene and may, for example, have a smooth, brightly colored outer surface attractive to the consumer.

Attached to the outer surface of the shell skirt 27 are a series of axially extending ribs 20 angularly spaced about the axis 18 and running from the lower rim 28 to the top wall 14 where they may join at a top pad 22 of a diameter less than the top wall 14 of the cap shell 12. At the lower rim 28 of the cap shell 12, the ribs 20 join a ring-shaped gasket 26. The gasket 26 extends under the rim 28 to abut a shoulder 19 of the container 15 when the grip cap 10 is in position closing the container 15.

The ribs 20, the gasket 26, and the top disk 22 are part of an over molded grip layer formed in the second operation of a two-shot molding process (described below) of an elastomeric resin material such as thermoplastic vulcanate (TPV) or thermoplastic elastomer (TPE) and may be of the same or a contrasting color as the shell 12. During this two-shot molding process, the ribs 20, the gasket 26, and the top disk 22 are fused to the material of the shell 12 without the need for adhesive or the like.

The ribs 20 provide an improved gripping surface for a user's fingers when the grip cap 10 must be turned about axis 18, and along with the top pad 22 provide cushioning for the underlying cap shell 12 against possible impact while using minimal amounts of the elastomeric material. The gasket 26 may provide for a resilient sealing against the container 15 and a frictional contact holding the grip cap 10 closed against rotation when it is sealed. The gasket 26 also accommodates shrinkage of the material of the cap shell 12 before the over molding without the need for other compensation mechanisms.

Portions of the material of the cap shell 12 may be molded to extend upward through the top pad 22 to present letters 30 or decorative embossments. Extending downward from the upper inner surface of the cap shell 12 may be one or more flanges 32 to directly engage the container 15 or, as shown, to hold a conventional threaded inner cap 34 having threads 36 to engage corresponding threads 37 on the container 15 and a gasket material 38 providing sealing on the neck 17 of the container 15 when the cap 10 is in position. Although not shown, the flanges 32 preferably have inwardly extending lips (generally parallel to the top wall 14) and can also have vertical ribbing that mates with corresponding vertical ribs on the inner cap 34 such that their engagement prevent relative rotation.

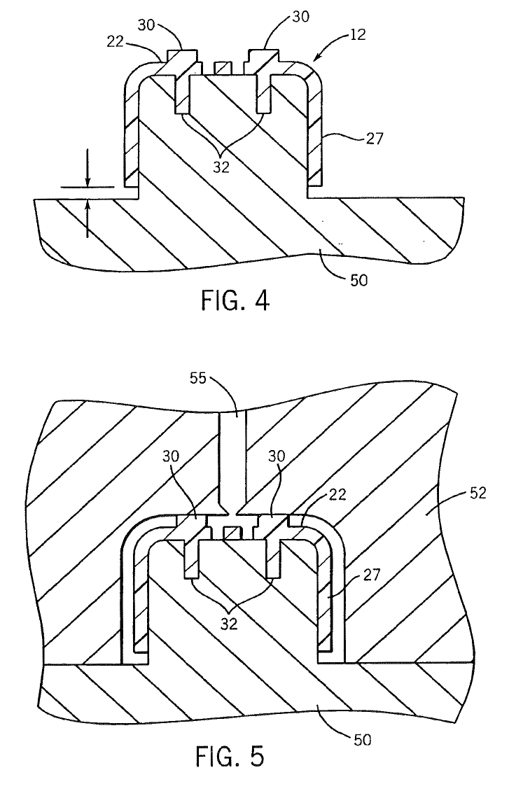

Referring to FIGS. 3-5, as mentioned, preferably the grip cap 10 is formed using a two-shot molding process. Specifically, a thermoplastic resin is injected between two halves 50 and 51 of a die 54 (though passage 53) of the die to form the cap shell. After sufficient cooling period, the two die parts are split by withdrawing part 51 away from part 50 and retaining the cap shell 12 on die part 50, as shown in FIG. 4. The removed die part 51 is then interchanged with another die part 52 having an interior surface configured to form the resilient grip layer, including the top pad 22, the ribs 20 and the gasket 26. As the cap shell 12 cools it shrinks on the supporting die part 50 so that the lower rim 28 is spaced from an adjacent surface of the die part 50. The gap illustrated in FIG. 4 is thus formed as the cap shell 12 is supported by die part 50 at the top wall 14. The new die part 50 is then joined to the original die part 50 with the cap shell 12 therebetween and an elastomeric resin is injected (through passage 55) around the cap shell 12 between die parts 50 to mold the grip layer integrally with the cap shell 12. This technique thus allows the grip layer to be molded onto an underside (at the lower rim 28) and the outer surfaces of the cap shell 12 simultaneously in a single operation.

The grip cap of the present invention thus has an improved gripping surface for a user's fingers when loosening the cap from or tightening the cap onto a container. The ribs and top pad provide cushioning for the underlying shell against possible impact while using minimal amounts of the elastomeric material. The gasket may provide for resilient sealing against the container and frictional contact holding the cap closed against rotation when it is sealed. The grip cap can be adapted to be connected to conventional threaded and other suitable under closures for closing an opening in the container.

It should be appreciated that merely a preferred embodiment of the invention has been described above. However, many modifications and variations to the preferred embodiment will be apparent to those skilled in the art, which will be within the spirit and scope of the invention. For example, the cap may be used in non-threaded applications, for example, as press fit to the top of the container or in snap-type closures as are well known in the art. Therefore, the invention should not be limited to the described embodiment. To ascertain the full scope of the invention, the following claims should be referenced.

We claim:

1. A method of molding a grip cap for a container, comprising the steps of:
(1) injecting a first thermoplastic material into a mold to form a cap shell having a top wall and a skirt depending down from the top wall to a lower rim, the cap shell for receiving a neck of the container, the cap shell having an outer surface and an underside including the lower rim; and
(2) injecting a second thermoplastic material into the mold to form a grip layer of a material different from a material of the cap shell, the grip layer having a plurality of vertically extending ribs, fused to the cap shell during molding, and raised from the outer surface of the cap shell in spaced relation, the ribs exposing the cap shell therebetween and extending along the skirt between the top wall and the lower rim, the ribs being resilient relative to the cap shell.

2. The method of claim 1, wherein the second thermoplastic material is an elastomeric material.

3. The method of claim 1, wherein the first thermoplastic material is polypropylene.

4. The method of claim 1, wherein the ribs are spaced equi-angularly about an axis about which the cap shell is concentric.

5. The method of claim 1, wherein the grip layer further includes a pad integrally molded to an upper surface of the cap shell top wall.

6. The method of claim 5, wherein the pad and the ribs join together at the pad.

7. The method of claim 5, wherein the pad has a diameter less than the top wall of the cap shell.

8. The method of claim 5, wherein the cap shell is molded to extend upward through the pad to present raised indicia.

9. The method of claim 1, wherein the ribs join at a gasket of the second thermoplastic material extending along the underside of the lower rim.

10. The method of claim 1, wherein the cap shell has one or more flanges surrounded by the skirt and extending down from the top wall sized to directly engage the container.

11. The method of claim 1, wherein the cap shell has one or more flanges surrounded by the skirt and extending down from the top wall and further including the step of fitting an inner cap to the flanges, the inner cap adapted to be removably mounted over an opening of the container.

12. The method of claim 1, wherein the mold has a first, second and third part and wherein
the injecting of the first thermoplastic material is into a combination of the first and second parts of the mold such that the outside of the cap shell is formed by the first mold part and the inside of the cap shell is formed by the second mold part; and wherein
the injecting of the second thermoplastic material is into a combination of the third and second parts of the mold after interchanging the first part of the mold with the second part of the mold; and further including the step of:
allowing the cap shell to shrink on the first die part so that the lower rim is spaced from an adjacent surface of the first die part before injection of the second thermoplastic material.

13. The method of claim 42, wherein the grip layer is formed by injecting an elastomeric resin between the cap shell and the second and third die parts.

14. The method of claim 42, wherein the cap shell is formed by injecting a non-elastomeric resin between the first and second die parts.

15. A two-shot method of making a grip cap for a container, comprising the steps of:
(a) molding in a die having a first part and a second part a cap shell conforming to the interior of the die so as to have a top wall and a skirt bounded by a lower rim at an angle to an outer surface of the skirt;
(b) supporting the cap shell on the first die part; interchanging the second die part with a third die part; allowing the cap shell to shrink on the first die part so that the lower rim is spaced from an adjacent surface of the first die part;
(c) joining the first and third die parts with the cap shell therebetween; and
(d) molding a grip layer integrally with the cap shell having a plurality of raised ribs extending along the outer surface of the skirt and a gasket extending along the lower rim.

16. The method of claim 15, wherein the cap shell is formed by injecting a thermoplastic resin between the first and second die parts and wherein the grip layer is formed by injecting an elastomeric resin between the cap shell and the first and third die parts.
